(19) United States
(12) Patent Application Publication
(10) Pub. No.: US 2026/0095718 A1
(43) Pub. Date: Apr. 2, 2026

(54) CONTROL DEVICE FOR SPATIAL SOUND EFFECT OF HEADPHONE AND CONTROL METHOD THEREOF

(71) Applicant: Acer Incorporated, New Taipei City (TW)

(72) Inventors: Po-Jen TU, New Taipei City (TW); Jia-Ren CHANG, New Taipei City (TW); Kai-Meng TZENG, New Taipei City (TW)

(73) Assignee: Acer Incorporated, New Taipei City (TW)

(21) Appl. No.: 19/227,013

(22) Filed: Jun. 3, 2025

(30) Foreign Application Priority Data
Sep. 27, 2024 (TW) 113137073

(51) Int. Cl. H04S 7/00

(52) U.S. Cl. CPC H04S 7/304; H04S 2400/15; H04S 2420/01

(57) ABSTRACT

A control device for spatial sound effect of a headphone and a control method thereof are provided. The control device includes a receiving unit, a head tracking unit, at least three equalizers, a switch and a controller. The at least three equalizers are configured to process an original sound signal according to a head direction to obtain at least a first adjusted sound signal, a second adjusted sound signal, and a third adjusted sound signal. The switch is configured to output the first adjusted sound signal according to the head direction. If the head direction has changed to a first expected rotation direction, the controller controls the switch to output the second adjusted sound signal; and if the head direction has changed to a second expected rotation direction, the controller controls the switch to output the third adjusted sound signal.

This application claims the benefit of Taiwan application Serial No. 113137073, filed September 27, 2024, the disclosure of which is incorporated by reference herein in its entirety.

### TECHNICAL FIELD

The disclosure relates in general to a control device and a control method for a headphone, and more particularly to a control device and a control method for spatial sound effect of a headphone.

### BACKGROUND

Currently, headphones are equipped with spatial sound effect functions to provide enhanced spatial stereophonic immersion. When the user rotates their head, the sound signal of the headphone must be continuously adjusted according to the user's head rotation in order to generate spatial sound effects.

However, when the sound signal received by the headphone is being adjusted, the user may experience a sense of discontinuity in hearing. In order to reduce the sense of discontinuity in the sound signal, researchers are actively developing and working to improve solutions to address this issue.

### SUMMARY

The present disclosure is directed to a control device and a control method for spatial sound effect of a headphone, which performs spatial sound effect adjustments on an original sound signal in advance. Once the user's head rotates, it can immediately switch to the adjusted sound signal corresponding to the rotated head direction, so as to avoid a sense of discontinuity in the sound signal.

According to one embodiment, a control method for spatial sound effect of a headphone is provided. The control method for spatial sound effect of the headphone includes the following steps. An original sound signal is received. A head direction is tracked. The original sound signal is processed using at least three equalizers according to the head direction to obtain at least a first adjusted sound signal, a second adjusted sound signal, and a third adjusted sound signal. The first adjusted sound signal corresponds to the head direction, the second adjusted sound signal corresponds to a first expected rotation direction, and the third adjusted sound signal corresponds to a second expected rotation direction. The first adjusted sound signal is outputted according to the head direction. Whether the head direction has changed to the first expected rotation direction or the second expected rotation direction is determined. If the head direction has changed to the first expected rotation direction, the second adjusted sound signal is outputted. If the head direction has changed to the second expected rotation direction, the third adjusted sound signal is outputted.

According to another embodiment, a control device for spatial sound effect of a headphone is provided. The control device includes a receiving unit, a head tracking unit, at least three equalizers, a switch and a controller. The receiving unit is configured to receive an original sound signal. The head tracking unit is configured to track a head direction. The at least three equalizers are configured to process the original sound signal according to the head direction to obtain at least a first adjusted sound signal, a second adjusted sound signal, and a third adjusted sound signal. The first adjusted sound signal corresponds to the head direction, the second adjusted sound signal corresponds to a first expected rotation direction, and the third adjusted sound signal corresponds to a second expected rotation direction. The switch is configured to output the first adjusted sound signal according to the head direction. The controller is configured to determine whether the head direction has changed to the first expected rotation direction or the second expected rotation direction. If the head direction has changed to the first expected rotation direction, the controller controls the switch to output the second adjusted sound signal; and if the head direction has changed to the second expected rotation direction, the controller controls the switch to output the third adjusted sound signal.

### BRIEF DESCRIPTION OF THE DRAWINGS

FIG. 1 is a schematic diagram illustrating a control method for spatial sound effect of a headphone according to an embodiment of the present disclosure.

FIG. 2 illustrates a waveform diagram of the sound signal received by the headphone when the user rotates his head.

FIG. 3A illustrates a block diagram of a control device for spatial sound effect of a headphone according to an embodiment of the present disclosure.

FIG. 3B illustrates a schematic diagram of head directions of the user.

FIG. 4 illustrates a flowchart of a control method for spatial sound effect of the headphone according to an embodiment of the present disclosure.

FIG. 5A illustrates a block diagram of the control device for spatial sound effect of the headphone according to another embodiment of the present disclosure.

FIG. 5B illustrates a schematic diagram of the head directions of the user.

FIG. 6A illustrates a block diagram of the control device for spatial sound effect of the headphone according to another embodiment of the present disclosure.

FIG. 6B illustrates a schematic diagram of the head directions of the user.

FIG. 7A illustrates a block diagram of the control device for spatial sound effect of the headphone according to another embodiment of the present disclosure.

FIG. 7B illustrates a schematic diagram of the head directions of the user.

FIG. 8A illustrates a block diagram of a control device for spatial sound effect of the headphone according to another embodiment of the present disclosure.

FIG. 8B illustrates a schematic diagram of the head directions of the user.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

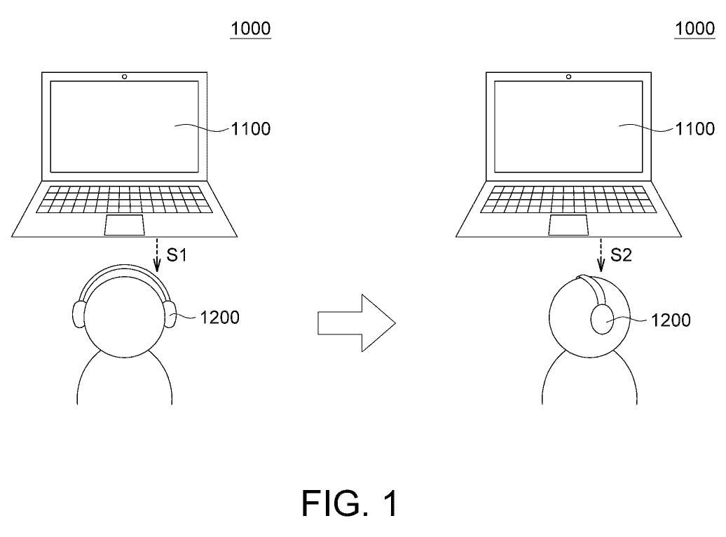

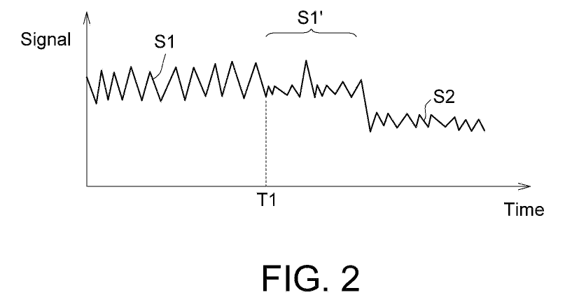

Please refer to FIGS. 1 and 2 simultaneously. FIG. 1 is a schematic diagram illustrating a control method for spatial sound effect of a headphone according to an embodiment of the present disclosure. FIG. 2 illustrates a waveform diagram of the sound signal received by the headphone when the user rotates his head. For example, the user is facing a display 1100 of a computer 1000 and wearing a headphone 1200, in order to listen to music, watch movies, listen to presentations, or participate in video conferences. The computer 1000 transmits a first sound signal S1 to the headphone 1200. When the computer 1000 detects that the user's head has rotated, the computer 1000 uses an equalizer to adjust the first sound signal S1 to generate a second sound signal S2, and then transmits the second sound signal S2 to the headphone 1200, in order to present a three-dimensional spatial sound effect experience.

Please refer to FIG. 2. At time point T1, when the first sound signal S1 is converted to the second sound signal S2, a short segment of noise S1′ may briefly occur, for example, lasting 0.5 milliseconds or 1 millisecond, causing the user to perceive a sense of discontinuity in hearing.

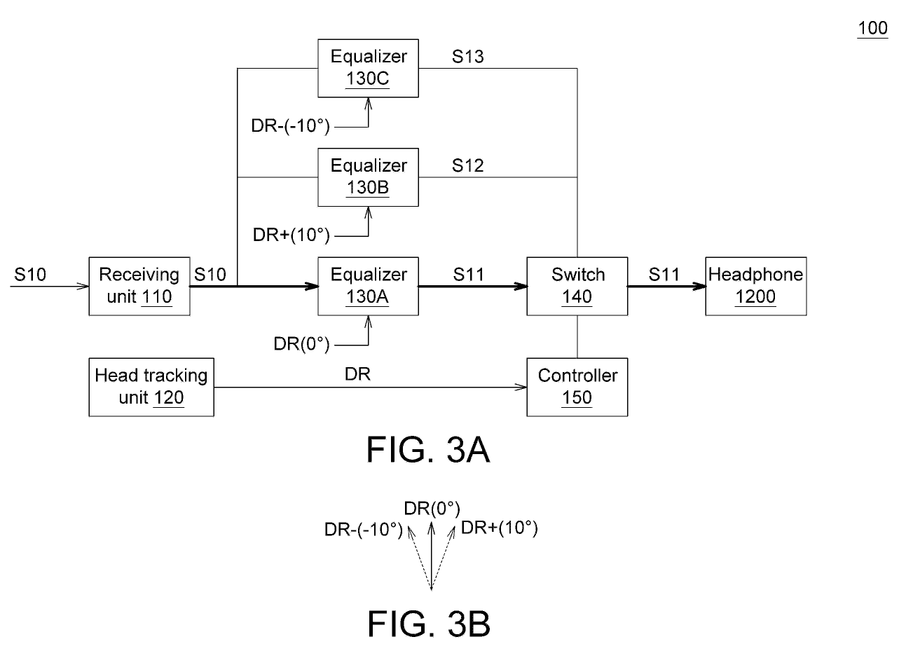

Please refer to FIG. 3A, which illustrates a block diagram of a control device 100 for spatial sound effect of the headphone 1200 according to an embodiment of the present disclosure. The control device 100 for spatial sound effect of the headphone 1200 includes a receiving unit 110, a head-tracking unit 120, at least three equalizers 130A, 130B, and 130C, a switch 140, and a controller 150.

The receiving unit 110 is configured to receive various signals and information. The head-tracking unit 120 is configured for head tracking, such as a combination of a camera and facial recognition device, an infrared detector, or a laser detector. The equalizers 130A, 130B, 130C, the switch 140, and the controller 150 are configured to perform signal processing, signal switching, and control operations, and may be implemented as a circuit, a circuit board, a storage device storing program code, or a chip. The chip may be, for example, a central processing unit (CPU), or other programmable general-purpose or special-purpose microcontroller unit (MCU), microprocessor, digital signal processor (DSP), programmable controller, application-specific integrated circuit (ASIC), graphics processing unit (GPU), image signal processor (ISP), image processing unit (IPU), arithmetic logic unit (ALU), complex programmable logic device (CPLD), field programmable gate array (FPGA), or other similar components or a combination thereof.

In this embodiment, at least three equalizers 130A, 130B, and 130C are used to pre-process the original sound signal S10, so that signal switching can be performed directly when the head rotates, thereby avoiding the sense of discontinuity. A flowchart is provided below to explain the operation of each component in detail.

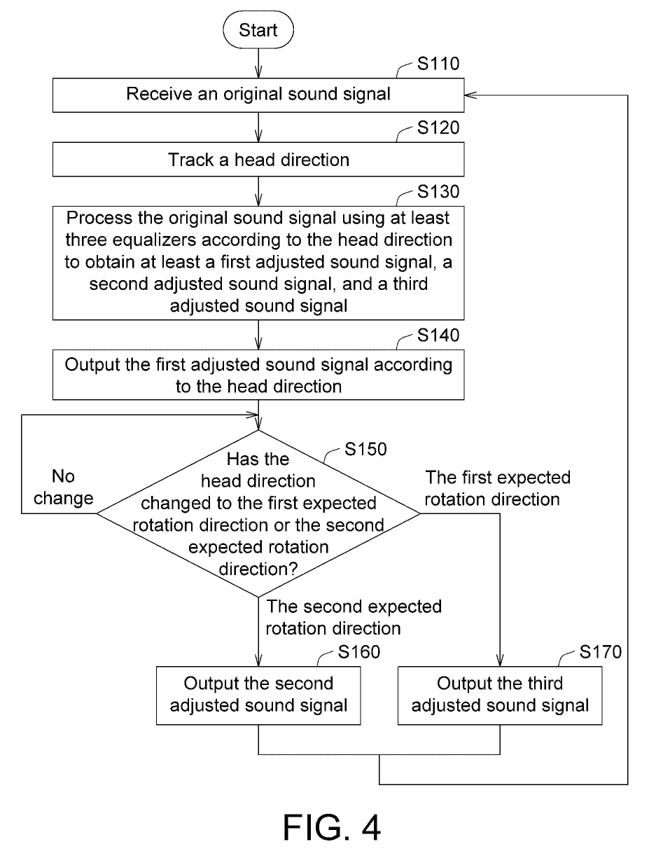

Please refer to FIG. 4, which illustrates a flowchart of a control method for spatial sound effect of the headphone 1200 according to an embodiment of the present disclosure. The control method for spatial sound effect of the headphone 1200 includes steps S110 to S170. In the step S110, as shown in the FIG. 3A, the receiving unit 110 receives an original sound signal S10.

Next, in the step S120, as shown in the FIG. 3A, the head-tracking unit 120 tracks a head direction DR of the user. Please refer to FIG. 3B, which illustrates a schematic diagram of the head directions DR of the user. When the user is directly facing the screen 1100 (as shown in FIG. 1), the head direction DR is at an angle of 0 degrees. When the user's head rotates 10 degrees clockwise, the head direction DR changes to 10 degrees, so the first expected rotation direction DR+ is set to 10 degrees. When the user's head rotates 10 degrees counterclockwise, the head direction DR changes to -10 degrees, so the second expected rotation direction DR− is set to -10 degrees. The first expected rotation direction DR+ and the second expected rotation direction DR− are opposite. The rotation angles of the first expected rotation direction DR+ and the second expected rotation direction DR− are the same, for example, 10 degrees. In another embodiment, the rotation angles of DR+ and DR− may be different.

Then, in the step S130, as shown in the FIG. 3A, the equalizers 130A, 130B, and 130C process the original sound signal S10 according to the head direction DR to obtain at least a first adjusted sound signal S11, a second adjusted sound signal S12, and a third adjusted sound signal S13. The first adjusted sound signal S11 outputted from equalizer 130A corresponds to the head direction DR (0 degrees), the second adjusted sound signal S12 outputted from the equalizer 130B corresponds to the first expected rotation direction DR+ (10 degrees), and the third adjusted sound signal S13 outputted from the equalizer 130C corresponds to the second expected rotation direction DR− (-10 degrees). These equalizers 130A, 130B, and 130C synchronously process the original sound signal S10.

Next, in the step S140, as shown in the FIG. 3A, the switch 140 outputs the first adjusted sound signal S11 to the headphone 1200 according to the current head direction DR (as shown in FIG. 3B, the head direction DR is 0 degrees).

Then, in the step S150, as shown in the FIG. 3A, the controller 150 determines whether the head direction DR (0 degrees) has changed to the first expected rotation direction DR+ (10 degrees) or the second expected rotation direction DR− (-10 degrees). If the head direction DR (0 degrees) changes to the first expected rotation direction DR+ (10 degrees), the process proceeds to step S160. If the head direction DR (0 degrees) changes to the second expected rotation direction DR− (-10 degrees), the process proceeds to the step S170.

For example, as shown in the FIG. 3B, when the head-tracking unit 120 detects that the user’s head rotates 10 degrees clockwise, the head direction DR (0 degrees) changes to the first expected rotation direction DR+ (10 degrees), and the process proceeds to the step S160. If the head-tracking unit 120 detects that the user’s head rotates 10 degrees counterclockwise, the head direction DR (0 degrees) changes to the second expected rotation direction DR− (-10 degrees), and the process proceeds to the step S170.

In the step S160, as shown in FIG. 3A, the controller 150 controls the switch 140 to output the second adjusted sound signal S12 to the headphone 1200.

In the step S170, as shown in the FIG. 3A, the controller 150 controls the switch 140 to output the third adjusted sound signal S13 to the headphone 1200.

The following description continues under the condition that the user's head has already rotated 10 degrees clockwise.

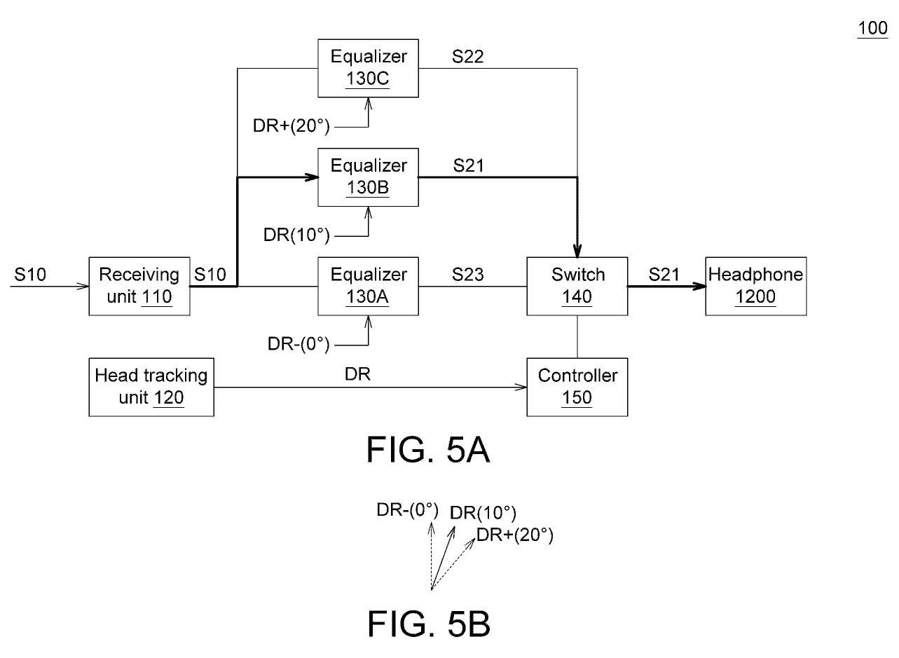

Please refer to FIG. 4, FIGS. 5A, and 5B. FIG. 5A illustrates a block diagram of the control device 100 for spatial sound effect of the headphone 1200 according to another embodiment of the present disclosure. FIG. 5B illustrates a schematic diagram of the head directions DR of the user.

In this embodiment, the user's head has already rotated to a position of 10 degrees. In the steps S110 to S120, after the receiving unit 110 receives the original audio signal S10, the head tracking unit 120 tracks that the user's head direction DR is at 10 degrees. Next, when the user's head rotates clockwise by 10 degrees, the head direction DR will change to 20 degrees, so the first expected rotation direction DR+ is set to 20 degrees; when the user's head rotates counterclockwise by 10 degrees, the head direction DR will change to 0 degrees, so the second expected rotation direction DR− is set to 0 degrees.

Next, in the step S130, as shown in the FIGS. 5A to 5B, the equalizers 130A, 130B, and 130C process the original audio signal S10 according to the head direction DR to obtain at least a first adjusted audio signal S21, a second adjusted audio signal S22, and a third adjusted audio signal S23. The first adjusted audio signal S21 outputted by the equalizer 130A corresponds to the head direction DR (10 degrees); the second adjusted audio signal S22 outputted by the equalizer 130B corresponds to the first expected rotation direction DR+ (20 degrees); the third adjusted audio signal S23 outputted by the equalizer 130C corresponds to the second expected rotation direction DR− (0 degrees). These equalizers 130A, 130B, and 130C synchronously process the original audio signal S10.

Next, in the step S140, as shown in the FIGS. 5A to 5B, the switch 140 outputs the first adjusted audio signal S21 to the headphone 1200 according to the current head direction DR (as shown in FIG. 5B, the head direction DR is 10 degrees).

Then, in the step S150, as shown in the FIGS. 5A to 5B, the controller 150 determines whether the head direction DR (10 degrees) changes to the first expected rotation direction DR+ (20 degrees) or the second expected rotation direction DR− (0 degrees). If the head direction DR (10 degrees) changes to the first expected rotation direction DR+ (20 degrees), the process proceeds to the step S160; if the head direction DR (10 degrees) changes to the second expected rotation direction DR− (0 degrees), the process proceeds to the step S170.

For example, as shown in the FIGS. 5A to 5B, when the head tracking unit 120 tracks that the user's head rotates clockwise by 10 degrees, the head direction DR (10 degrees) changes to the first expected rotation direction DR+ (20 degrees), and the process proceeds to the step S160. If the head tracking unit 120 tracks that the user's head rotates counterclockwise by 10 degrees, the head direction DR (10 degrees) changes to the second expected rotation direction DR− (0 degrees), and the process proceeds to the step S170.

In the step S160, as shown in the FIGS. 5A to 5B, the controller 150 controls the switch 140 to output the second adjusted audio signal S22 to the headphone 1200.

In the step S170, as shown in the FIGS. 5A to 5B, the controller 150 controls the switch 140 to output the third adjusted audio signal S23 to the headphone 1200.

The following description continues under the condition where the user's head has further rotated clockwise by 10 degrees.

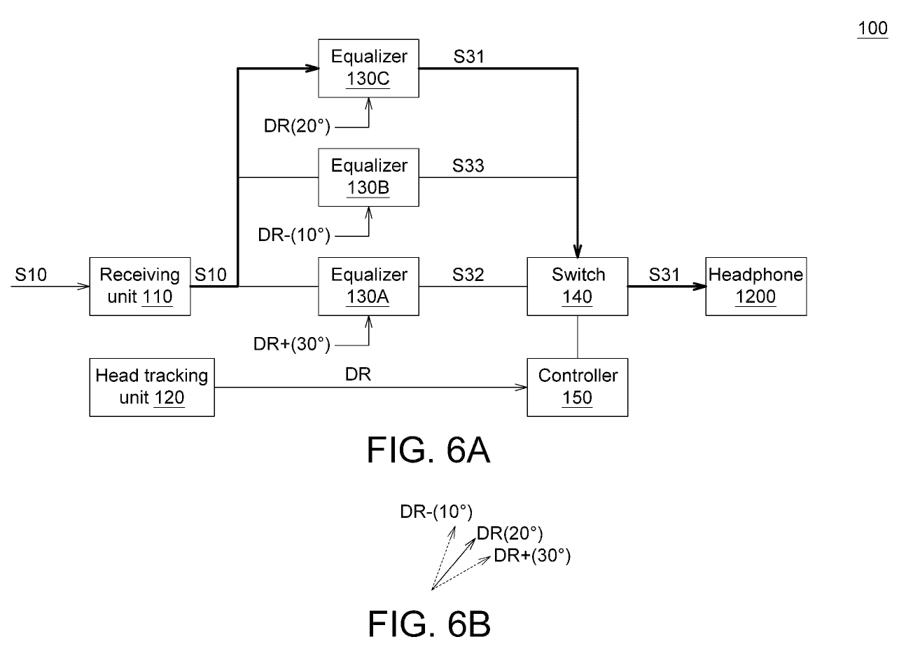

Please refer to FIG. 4, FIGS. 6A, and 6B simultaneously. FIG. 6A illustrates a block diagram of the control device 100 for spatial sound effect of the headphone 1200 according to another embodiment of the present disclosure. FIG. 6B illustrates a schematic diagram of the head directions DR of the user.

In this embodiment, the user’s head has already rotated to a position of 20 degrees. In the steps S110 to S120, after the receiving unit 110 receives the original sound signal S10, the head tracking unit 120 tracks that the user's head direction DR is at 20 degrees. Next, when the user's head rotates 10 degrees clockwise, the head direction DR will change to 30 degrees, so the first expected rotation direction DR+ is set to 30 degrees; when the user's head rotates 10 degrees counterclockwise, the head direction DR will change to 10 degrees, so the second expected rotation direction DR– is set to 10 degrees.

Next, in the step S130, as shown in the FIGS. 6A to 6B, the equalizers 130A, 130B, and 130C process the original sound signal S10 according to the head direction DR, to at least obtain a first adjusted sound signal S31, a second adjusted sound signal S32, and a third adjusted sound signal S33. The first adjusted sound signal S31 outputted by the equalizer 130A corresponds to the head direction DR (20 degrees), the second adjusted sound signal S32 outputted by the equalizer 130B corresponds to the first expected rotation direction DR+ (30 degrees), and the third adjusted sound signal S33 outputted by the equalizer 130C corresponds to the second expected rotation direction DR– (10 degrees). These equalizers 130A, 130B, and 130C synchronously process the original sound signal S10.

Next, in the step S140, as shown in the FIGS. 6A to 6B, the switch 140 outputs the first adjusted sound signal S31 to the headphone 1200 according to the current head direction DR (as shown in FIG. 6B, the head direction DR is 20 degrees).

Then, in the step S150, as shown in the FIGS. 6A to 6B, the controller 150 determines whether the head direction DR (20 degrees) has changed to the first expected rotation direction DR+ (30 degrees) or the second expected rotation direction DR– (10 degrees). If the head direction DR (20 degrees) changes to the first expected rotation direction DR+ (30 degrees), the process proceeds to the step S160; if the head direction DR (20 degrees) changes to the second expected rotation direction DR– (10 degrees), the process proceeds to the step S170.

For example, as shown in the FIGS. 6A to 6B, when the head tracking unit 120 tracks that the user’s head rotates 10 degrees clockwise, the head direction DR (20 degrees) changes to the first expected rotation direction DR+ (30 degrees), and the process proceeds to the step S160. If the head tracking unit 120 tracks that the user’s head rotates 10 degrees counterclockwise, the head direction DR (20 degrees) changes to the second expected rotation direction DR– (10 degrees), and the process proceeds to the step S170.

In the step S160, as shown in the FIGS. 6A to 6B, the controller 150 controls the switch 140 to output the second adjusted sound signal S32 to the headphone 1200.

In the step S170, as shown in the FIGS. 6A to 6B, the controller 150 controls the switch 140 to output the third adjusted sound signal S33 to the headphone 1200.

The following description continues under the condition that the user's head has further rotated 10 degrees clockwise.

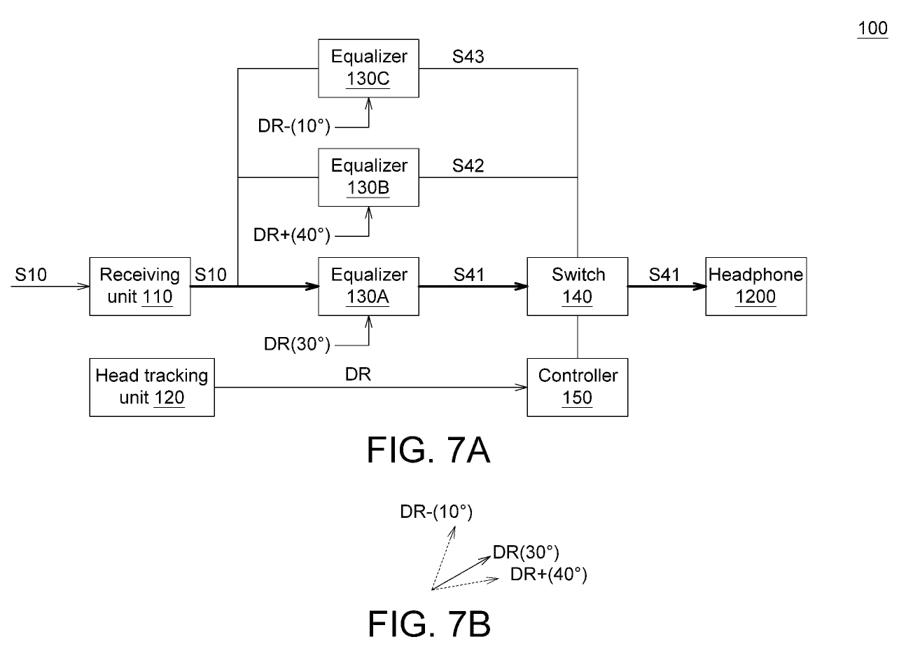

Please refer to FIG. 4, FIGS. 7A, and 7B simultaneously. FIG. 7A illustrates a block diagram of the control device 100 for spatial sound effect of the headphone 1200 according to another embodiment of the present disclosure. FIG. 7B illustrates a schematic diagram of the head directions DR of the user.

In this embodiment, the user's head has already rotated to a position of 30 degrees. In the steps S110 to S120, after the receiving unit 110 receives the original sound signal S10, the head tracking unit 120 tracks that the user's head direction DR is at 30 degrees.

In this embodiment, the rotation angles of the first expected rotation direction DR+ and the second expected rotation direction DR– are different. Since the user has already turned to 30 degrees, the probability of rotating counterclockwise is higher than that of rotating clockwise. Therefore, the rotation angle of the second expected rotation direction DR– could be set to 20 degrees, and the rotation angle of the first expected rotation direction DR+ could be set to 10 degrees.

Next, when the user's head rotates 10 degrees clockwise, the head direction DR will change to 40 degrees, so the first expected rotation direction DR+ is set to 40 degrees; when the user's head rotates 20 degrees counterclockwise, the head direction DR will change to 10 degrees, so the second expected rotation direction DR– is set to 10 degrees.

Next, in the step S130, as shown in the FIGS. 7A to 7B, the equalizers 130A, 130B, and 130C process the original sound signal S10 according to the head direction DR to at least obtain a first adjusted sound signal S41, a second adjusted sound signal S42, and a third adjusted sound signal S43. The first adjusted sound signal S41 outputted by the equalizer 130A corresponds to the head direction DR (30 degrees), the second adjusted sound signal S42 outputted by the equalizer 130B corresponds to the first expected rotation direction DR+ (40 degrees), and the third adjusted sound signal S43 outputted by the equalizer 130C corresponds to the second expected rotation direction DR– (10 degrees). These equalizers 130A, 130B, and 130C process the original sound signal S10 synchronously.

Next, in the step S140, as shown in the FIGS. 7A to 7B, the switch 140 outputs the first adjusted sound signal S41 to the headphone 1200 according to the current head direction DR (as shown in FIG. 7B, the head direction DR is 30 degrees).

Then, in the step S150, as shown in the FIGS. 7A to 7B, the controller 150 determines whether the head direction DR (30 degrees) has changed to the first expected rotation direction DR+ (40 degrees) or the second expected rotation direction DR– (10 degrees). If the head direction DR (30 degrees) changes to the first expected rotation direction DR+ (40 degrees), the process proceeds to the step S160; if the head direction DR (30 degrees) changes to the second expected rotation direction DR– (10 degrees), the process proceeds to the step S170.

For example, as shown in the FIGS. 7A to 7B, when the head tracking unit 120 tracks that the user’s head rotates 10 degrees clockwise, the head direction DR (30 degrees) changes to the first expected rotation direction DR+ (40 degrees), and step S160 is entered. If the head tracking unit 120 tracks that the user’s head rotates 20 degrees counterclockwise, the head direction DR (30 degrees) changes to the second expected rotation direction DR– (10 degrees), and the process proceeds to the step S170.

In the step S160, as shown in the FIGS. 7A to 7B, the controller 150 controls the switch 140 to output the second adjusted sound signal S42 to the headphone 1200.

In the step S170, as shown in the FIGS. 7A to 7B, the controller 150 controls the switch 140 to output the third adjusted sound signal S43 to the headphone 1200.

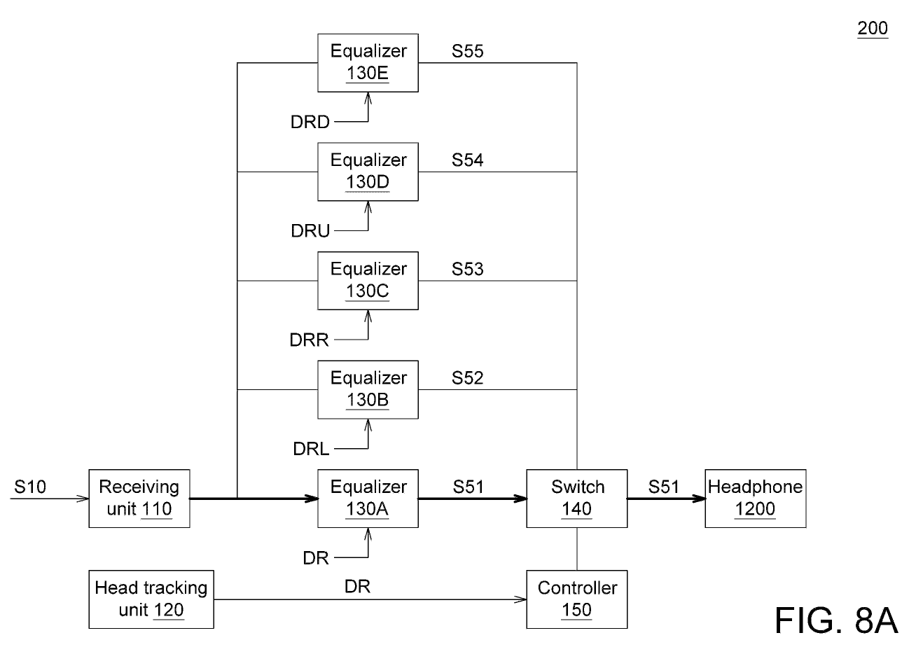

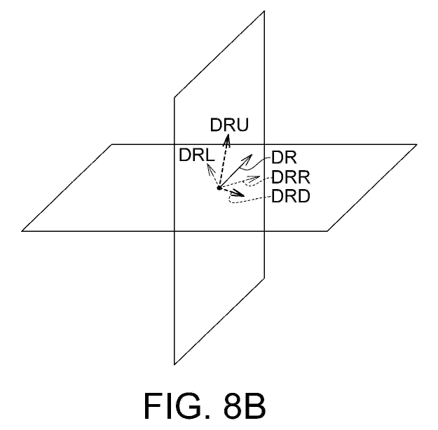

In another embodiment, please refer to FIGS. 8A and 8B simultaneously. FIG. 8A illustrates a block diagram of a control device 200 for spatial sound effect of the headphone 1200 according to another embodiment of the present disclosure. FIG. 8B illustrates a schematic diagram of the head directions DR of the user. The control device 200 for spatial sound effect of the headphone 1200 includes the above-mentioned receiving unit 110, the above-mentioned head tracking unit 120, five equalizers 130A, 130B, 130C, 130D, 130E, the above-mentioned switch 140, and the above-mentioned controller 150.

In this embodiment, the rotation direction of the user's head includes both horizontal and vertical directions. As shown in the FIG. 8B, a first expected rotation direction DRL is leftward rotation, a second expected rotation direction DRR is rightward rotation, a third expected rotation direction DRU is upward rotation, and a fourth expected rotation direction DRD is downward rotation.

The first adjusted sound signal S51 outputted by the equalizer 130A corresponds to the head direction DR; the second adjusted sound signal S52 outputted by the equalizer 130B corresponds to the first expected rotation direction DRL; the third adjusted sound signal S53 outputted by the equalizer 130C corresponds to the second expected rotation direction DRR; the fourth adjusted sound signal S54 outputted by the equalizer 130D corresponds to the third expected rotation direction DRU; and the fifth adjusted sound signal S55 outputted by the equalizer 130E corresponds to the fourth expected rotation direction DRD. These equalizers 130A, 130B, 130C, 130D, and 130E synchronously process the original sound signal S10.

In this embodiment, the five equalizers 130A, 130B, 130C, 130D, and 130E pre-process the original sound signal S10. When the head rotates horizontally or vertically, signal switching can be directly performed to avoid any sense of discontinuity.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A control method for spatial sound effect of a headphone, comprising:
receiving an original sound signal;
tracking a head direction;
processing the original sound signal using at least three equalizers according to the head direction to obtain at least a first adjusted sound signal, a second adjusted sound signal, and a third adjusted sound signal, wherein the first adjusted sound signal corresponds to the head direction, the second adjusted sound signal corresponds to a first expected rotation direction, and the third adjusted sound signal corresponds to a second expected rotation direction;
outputting the first adjusted sound signal according to the head direction;
determining whether the head direction has changed to the first expected rotation direction or the second expected rotation direction;
outputting the second adjusted sound signal, if the head direction has changed to the first expected rotation direction; and
outputting the third adjusted sound signal, if the head direction has changed to the second expected rotation direction.

2. The control method for spatial sound effect of the headphone according to claim 1, wherein the equalizers synchronously process the original sound signal.

3. The control method for spatial sound effect of the headphone according to claim 1, wherein the first expected rotation direction is opposite to the second expected rotation direction.

4. The control method for spatial sound effect of the headphone according to claim 1, wherein a rotation angle of the first expected rotation direction is identical to a rotation angle of the second expected rotation direction.

5. The control method for spatial sound effect of the headphone according to claim 4, wherein the rotation angle of the first expected rotation direction is 10 degrees and the rotation angle of the second expected rotation direction is 10 degrees.

6. The control method for spatial sound effect of the headphone according to claim 1, wherein a rotation angle of the first expected rotation direction is different from a rotation angle of the second expected rotation direction.

7. The control method for spatial sound effect of the headphone according to claim 6, wherein the rotation angle of the first expected rotation direction is 10 degrees and the rotation angle of the second expected rotation direction is 20 degrees.

8. The control method for spatial sound effect of the headphone according to claim 1, wherein the step of obtaining the first adjusted sound signal, the second adjusted sound signal, and the third adjusted sound signal is performed before the step of determining whether the head direction has changed to the first expected rotation direction or the second expected rotation direction.

9. The control method for spatial sound effect of the headphone according to claim 1, wherein all of the first adjusted sound signal, the second adjusted sound signal, and the third adjusted sound signal are outputted by the headphone.

10. The control method for spatial sound effect of the headphone according to claim 1, wherein the first adjusted sound signal, the second adjusted sound signal, and the third adjusted sound signal are outputted asynchronously.

11. A control device for spatial sound effect of a headphone, comprising:
a receiving unit, configured to receive an original sound signal;
a head tracking unit, configured to track a head direction;
at least three equalizers, configured to process the original sound signal according to the head direction to obtain at least a first adjusted sound signal, a second adjusted sound signal, and a third adjusted sound signal, wherein the first adjusted sound signal corresponds to the head direction, the second adjusted sound signal corresponds to a first expected rotation direction, and the third adjusted sound signal corresponds to a second expected rotation direction;
a switch, configured to output the first adjusted sound signal according to the head direction; and
a controller, configured to determine whether the head direction has changed to the first expected rotation direction or the second expected rotation direction;
wherein if the head direction has changed to the first expected rotation direction, the controller controls the switch to output the second adjusted sound signal; and if the head direction has changed to the second expected rotation direction, the controller controls the switch to output the third adjusted sound signal.

12. The control device for spatial sound effect of the headphone according to claim 11, wherein the equalizers synchronously process the original sound signal.

13. The control device for spatial sound effect of the headphone according to claim 11, wherein the first expected rotation direction is opposite to the second expected rotation direction.

14. The control device for spatial sound effect of the headphone according to claim 11, wherein a rotation angle of the first expected rotation direction is identical to a rotation angle of the second expected rotation direction.

15. The control device for spatial sound effect of the headphone according to claim 14, wherein the rotation angle of the first expected rotation direction is 10 degrees and the rotation angle of the second expected rotation direction is 10 degrees.

16. The control device for spatial sound effect of the headphone according to claim 11, wherein a rotation angle of the first expected rotation direction is different from a rotation angle of the second expected rotation direction.

17. The control device for spatial sound effect of the headphone according to claim 11, wherein the rotation angle of the first expected rotation direction is 10 degrees and the rotation angle of the second expected rotation direction is 20 degrees.

18. The control device for spatial sound effect of the headphone according to claim 11, wherein before the controller determines whether the head direction has changed to the first expected rotation direction or the second expected rotation direction, the equalizers obtain the first adjusted sound signal, the second adjusted sound signal, and the third adjusted sound signal.

19. The control device for spatial sound effect of the headphone according to claim 11, wherein all of the first adjusted sound signal, the second adjusted sound signal, and the third adjusted sound signal are outputted by the headphone.

20. The control device for spatial sound effect of the headphone according to claim 11, wherein the first adjusted sound signal, the second adjusted sound signal, and the third adjusted sound signal are outputted asynchronously.
